(19) United States
(12) Patent Application Publication
(10) Pub. No.: US 2022/0344688 A1
(43) Pub. Date: Oct. 27, 2022

(54) Systems and Methods for Producing Hydrogen and Byproducts from Natural Gas at Fixed Points

(71) Applicant: Bionatus, LLC, Irvine, CA (US)

(72) Inventors: Peter Capuciati, Laguna Beach, CA (US); Matthew Case, Newport Beach, CA (US)

(21) Appl. No.: 17/727,581

(22) Filed: Apr. 22, 2022

Related U.S. Application Data
(60) Provisional application No. 63/178,449, filed on Apr. 22, 2021.
(60) Provisional application No. 63/178,459, filed on Apr. 22, 2021.
(60) Provisional application No. 63/178,464, filed on Apr. 22, 2021.
(60) Provisional application No. 63/178,476, filed on Apr. 22, 2021.
(60) Provisional application No. 63/178,478, filed on Apr. 22, 2021.

(51) Int. Cl. H01M 8/0612; H01M 16/00; B60L 50/70

(52) U.S. Cl. CPC H01M 8/0618; H01M 16/006; B60L 50/70; H01M 2250/20; H02J 7/342

(57) ABSTRACT

Fixed point applications of producing hydrogen from hydrocarbons and using such are described. A feedstock including natural gas is introduced to a plasma reformer, and H2 is generated from the feedstock. The plasma reformer can be integrated into a number of locations for various purposes. For example, reformers can be integrated into buildings for onsite generation of H2 , either for storage, distribution as fuel, or for generating electricity for onsite needs to alleviate strain on the energy grid. Likewise, legacy natural gas distribution points or fuel stations can be converted to H2 distribution points, or further used as electricity distribution points by way of an H2 fuel cell. Likewise, reformers can be integrated into natural gas distribution networks to self-energize nodes or stations in the network via H2 fuel cells.

This application claims the benefit of priority to U.S. Provisional Patent No. 63/178,449 filed Apr. 22, 2021, U.S. Provisional Patent No. 63/178,459 filed Apr. 22, 2021, U.S. Provisional Patent No. 63/178,464 filed Apr. 22, 2021, U.S. Provisional Patent No. 63/178,476 filed Apr. 22, 2021, U.S. Provisional Patent No. 63/178,478 filed Apr. 22, 2021, each of which is incorporated by reference in its entirety herein.

### FIELD OF THE INVENTION

The field of the invention is clean energy technologies.

### BACKGROUND

The background description includes information that may be useful in understanding the present invention. It is not an admission that any of the information provided herein is prior art or relevant to the presently claimed invention, or that any publication specifically or implicitly referenced is prior art.

Over the last couple of decades, the fight against climate change has gained significant urgency. This urgency has in turn inspired technical innovations that attempt to tackle the problem from different approaches.

One approach has been the development of electric vehicles. Electric vehicles have soared in popularity over the last decade, as battery technology has made viable designs possible. However, the technology still has significant hurdles to overcome before the internal combustion engine is rendered obsolete. On the production side, the materials required for battery production are very finite and may not support a truly global amount of vehicles. On the user side, charging times and range anxiety prevent electric vehicles from truly replacing traditional internal combustion engine-based vehicles.

Another approach has been the use of hydrogen as a fuel. Since the only byproduct of using hydrogen as a fuel is water, it is a very promising approach to environmentally-friendly energy. However, the production of hydrogen for use as fuel requires a great deal of energy. Moreover, hydrogen can be highly explosive, making the distribution of hydrogen a dangerous, costly process.

Hydrogen fuel cell vehicles have advantages over electric vehicles such as faster charging and a greatly-reduced battery size. Without the challenges associated with the generation and distribution of hydrogen, hydrogen fuel cell vehicles could surpass electric vehicles as a replacement for the traditional internal combustion engine.

Others have attempted to solve the challenge of generating hydrogen from natural gas. For example, the process for creating high-purity carbon black from natural gas by Monolith Materials, Inc. of Lincoln, Nebraska also results in hydrogen as a product. However, the facility required for this process is large and as such the problems associated with storage and distribution of hydrogen remain.

It is known to use a plasma reformer (plasmatron) to produce hydrocarbon-rich gas (50-75%) from natural gas (mostly methane), and then passing the hydrocarbon-rich gas to a fuel cell to produce electricity. See U.S. 5,409,784 (Bromberg, 1995), and L. Bromberg, D. R. Cohn and A. Rabinovich, “Plasma Reformer-Fuel Cell System For Decentralized Power Applications”, Int. J. Hydrogen Energy Vol 22., No. 1, pp 83094 (1997). Fuel cells combine the hydrogen-rich gas with oxygen from the air generate electricity and produce water. Suitable fuel cells are reported to include molten carbonate fuel cells (MCFC), solid oxide fuel cells (SOFC), and in phosphoric acid fuel cells (PAFC). This same prior art also teaches that the process can be utilized in a motor vehicle.

These and all other extrinsic materials are incorporated herein by reference in their entirety. Where a definition or use of a term in a reference that is incorporated by reference is inconsistent or contrary to the definition of that term provided herein, the definition of that term provided herein is deemed to be controlling.

Cross-reference is made to U.S. Provisional Patent No. 63/178,462 filed Apr. 22, 2021, U.S. Provisional Patent No. 63/178,470 filed Apr. 22, 2021, U.S. Provisional Patent No. 63/178,474 filed Apr. 22, 2021, U.S. Provisional Patent No. 63/178,484 filed Apr. 22, 2021 and U.S. Provisional Patent No. 63/178,488 filed Apr. 22, 2021, each of which is copending and filed by Applicant.

One difficulty with most of Bromberg's devices and methods is that the hydrogen-rich gas comprises 25-75% H2 and 25-40% carbon monoxide (CO). The CO can be converted into carbon dioxide (CO2) by injection of steam, which can interfere with operation of the fuel cells. Bromberg does teach an alternative embodiment, in which a plasmatron can be operated in a water-free, an oxygen deficient manner. In that embodiment, thermal decomposition eliminates production of both carbon monoxide (CO) and carbon dioxide (CO2), and produces mostly pure hydrogen and carbon (soot). A remaining problem, however, is that at much reduced efficiencies (e.g., 30% for CH4) due to the high temperatures (1,000°-3,000° C.) required.

What is needed are systems and methods in which CH4, other light hydrocarbons, or mixtures such as natural gas, can be used to efficiently produce electricity in situ, without significant release carbonaceous gasses into the atmosphere.

### SUMMARY OF THE INVENTION

Systems, methods, and devices to facilitate and effectuate fixed point applications of a natural gas reformer are contemplated. For example, an electric vehicle filling station is contemplated such that a feedstock source is coupled to a reformer, the reformer using a plasma to generate H2 from the feedstock. A fuel cell is coupled to the reformer and uses the H2 to generate electricity from the H2. An electric transmission point coupled to the fuel cell provides the generated electricity to an electric vehicle. In some embodiments a battery coupled to the fuel cell stores generated electricity, whether excess or intended for storage. The feedstock is natural gas or other hydrocarbons, favorably light hydrocarbons (e.g., <C5), whether alone or in mixtures.

A storage component is also coupled to the reformer to store H2, preferably pressurized. An H2 transmission point coupled to the storage then provides the generated H2 to an electric vehicle (e.g., for transport of H2) or to a fuel cell electric vehicle (e.g., for powering FCEV or for transport of H2). The reformer typically includes a plasma device or several, of different or the same variety. The generated electricity preferably powers the reformer once the system is activated (e.g., activated via starter, battery, grid, or manual crank, etc.). The electric vehicle is typically one of a land vehicle, an aircraft, a marine vessel, or a spacecraft.

Typically the reformer generates carbon from the feedstock, for example carbon black. A carbon repository can be coupled to the reformer to collect the carbon. Preferably the generated electricity further powers compression of the generated carbon. In most cases the generated carbon comprises at least 20% nanostructure carbon, which is preferably separated from the rest of the generated carbon.

Further methods of fueling an electric vehicle from a feedstock are contemplated. A reformer is used to generate H2 from a feedstock, preferably natural gas. Fuel is then provided to an electric vehicle, wherein the fuel comprises generated H2 or electricity generated by a fuel cell from the generated H2. The reformer typically uses one or more plasma devices to generate H2 from the feedstock. Electricity is generated from the H2 by a fuel cell and used to power the reformer.

Systems, methods, and devices for reducing demand on an energy grid serving an area are further contemplated. A feedstock is distributed to the area. Once in the area, H2 is produced from the feedstock using a reformer. A fuel cell then produces electricity from the H2, and the produced electricity is supplied to the local energy grid. The feedstock is typically natural gas or other (light) hydrocarbons. In some embodiments some of the produced electricity is stored in a battery in the local area, for example to further supplement the grid in surge conditions. In where multiple grids are involved, the feedstock is distributed to more than one grid in the area, and electricity is produced at each point to further supplement or ease strain on each grid. Similarly, in a geographically large grid or dense, urban grids the feedstock is distributed to more than one area in the energy grid, and electricity is produced in each area.

The feedstock is typically delivered to the area via a distribution line (e.g., e.g., natural gas pipeline, CNG pipeline, LNG pipeline, etc.). The feedstock is distributed to more than one area along the distribution line, and at each area H2 is produced from the feedstock using a reformer. A fuel cell is used to produce electricity from the H2, either for further distribution or storage. In some embodiments, the electricity is reserved specifically to service the local area. In some embodiments, produced H2 is stored in the area for use in surge conditions, though typically at a weight of less than 10% of H2 produced over a 24 hr period. Likewise, feedstock can be stored in the local area (e.g., for surge conditions), though typically no more than 10% of the weight distributed to the area over a 24 hr period.

Some of the produced electricity is favorably used to energize feedstock distribution, storage of distributed feedstock, H2 production, storage of produced H2, or otherwise operates the energy grid. In some embodiments, the produced electricity is further supplied to another energy grid (e.g., neighboring grid), the other energy grid having one of (i) local H2 production, (ii) local electricity production from H2, or (iii) no local H2 production. The reformer typically includes one or more plasma devices to generate the H2 from the feedstock. The feedstock can further be distributed to industrial, commercial, or residential buildings in the area for onsite use, for example reforming to H2 and generating electricity via fuel cell.

Further systems, methods, and devices for modifying or retrofitting a hydrocarbon distribution is contemplated. A hydrocarbon (preferably natural gas or light hydrocarbon) point is modified to include an H2 distribution point. A hydrocarbon supply line at the distribution point (e.g., preexisting line, legacy line, new line, etc.) is coupled to a reformer, and the reformer is further coupled to a H2 distribution point. The reformer is used to separate H2 from the hydrocarbon, typically with one or more plasma devices (e.g., DBD plasma, nonthermal plasma, microwave plasma, combinations thereof, etc.). Typically the hydrocarbon is natural gas and the hydrocarbon supply line is a natural gas supply line, for example a legacy line.

The H2 is typically produced for on-demand distribution, for example to FCEV as fuel or for transport, though the H2 can be stored for subsequent distribution at the distribution point. In some cases the H2 is compressed or pressurized (e.g., liquified) at the distribution point before storage or distribution. In some embodiments a fuel cell is coupled to the H2 distribution point and uses H2 at the distribution point to power the reformer, compression of the H2, the hydrocarbon distribution point, the H2 distribution point, or to otherwise operate the facility. Likewise, electricity generated by an onsite fuel cell can be used to charge an electric vehicle.

In some embodiments, the H2 distribution point replaces one or more, or all, legacy or preexisting hydrocarbon distribution points at the site. The H2 distribution point can provide H2 to any California DMV class of vehicle. A battery can also be coupled to the fuel cell, for example to store electricity from the fuel cell to operate the reformer, compression of the H2, the hydrocarbon distribution point, the H2 distribution point, charge an electric vehicle, or otherwise operate the site/facility.

Generally generating H2 from the hydrocarbon accumulates carbon (e.g., carbon black), and a carbon repository coupled to the reformer is used to collect accumulated carbon. The accumulated carbon is typically fluffy and is compressed for storage or transport. The accumulated carbon typically includes at least 20% carbon in nanostructure form, which can be separated from the other carbon for further processing or commercializing. The fuel cell typically powers compression of the carbon.

Further systems, methods, and devices for using a feedstock in a building are contemplated. A reformer is used to convert the feedstock (e.g., natural gas, hydrocarbon, light hydrocarbon) in part to H2 for use at the building. A fuel cell is then used at the building to generate electricity from the H2, wherein the electricity is used to operate the building. Once activated, the system can use the generated electricity to further operate the reformer. Produced H2 can also be stored at the building, preferably pressurized, condensed, or liquified. The produced H2 can also be supplied to another building, for example in a multi-building compound, campus, or facility. The produced H2 can also be provided to a California DMV class of vehicle, a locomotive, a propeller vehicle, a turbine vehicle, a sea craft, or a construction vehicle, typically as a fuel source (e.g., H2 burning ICE, fuel cell, etc.) though in some cases as a commodity for transport.

A battery at the building can also be used to store generated electricity, whether excess or dedicated for storage, for example to supplement energy demands of the building during surge or peak conditions. The building is typically a residential, commercial, industrial, or utility building. The fuel cell generates between 10-30 Kwh, 30-80 Kwh, 80-120 Kwh, or more than 120 Kwh per day, depending on the energy demands of the building or storage capacity. Likewise, the reformer converts 2-3 kg, 3-9 kg, 9-13 kg, or more than 13 Kg of feedstock per day. The generated electricity can also be provided to a California DMV class of vehicle, a locomotive, a propeller vehicle, a turbine vehicle, a sea craft, or a construction vehicle, for example to charge or energize the vehicle.

Further systems, methods, and devices of operating a hydrocarbon distribution system are contemplated. Where a hydrocarbon distribution system includes a plurality of operating nodes (e.g., meter station, service station, junction, distribution point, step-up or step-down point, etc.), a reformer is fluidly coupled to a hydrocarbon supply line of the distribution system, for example at an operating node. The reformer is used to generate H2, and is fluidly coupled to a fuel cell. The fuel cell generates electricity from the H2 to power the local operating node. The hydrocarbon is typically natural gas (e.g., CNG, LNG, etc.). Electricity generated by the fuel cell can further be stored at a battery coupled to the operating node.

In some embodiments, the operating node is one of a compressor station, a processing station, a gate station, or a distribution station. Generated H2 can also be stored at the operating node, whether pressurized, condensed, or liquified. The generated electricity or generated H2 can also be supplied to a California DMV class of vehicle, a construction vehicle, a piece of field equipment, a locomotive, or a transport ship at or near the operating node, either as a fuel source (e.g., EV, FCEV, H2 burning ICE, etc.) or for transport. The reformer typically uses one or more plasma devices to generate H2 from the feedstock, preferably a cold plasma reformer.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts an application of a system of the inventive subject matter.

FIG. 2 depicts a flow chart of a process of the inventive subject matter.

FIG. 3 depicts another application of a system of the inventive subject matter.

FIG. 4 depicts yet another application of a system of the inventive subject matter.

FIG. 5 depicts a device of the prior art.

FIG. 6 depicts another device of the prior art.

FIG. 7 depicts a system of the inventive subject matter.

FIG. 8 depicts another application of a system of the inventive subject matter.

FIG. 9 depicts yet another application of a system of the inventive subject matter.

FIG. 10 depicts still another application of a system of the inventive subject matter.

FIG. 11 depicts another application of a system of the inventive subject matter.

FIG. 12 depicts a system of the prior art.

FIG. 13 depicts yet another application of a system of the inventive subject matter.

### DETAILED DESCRIPTION

One should appreciate that the disclosed techniques provide many advantageous technical effects including simplifying clean energy production and use.

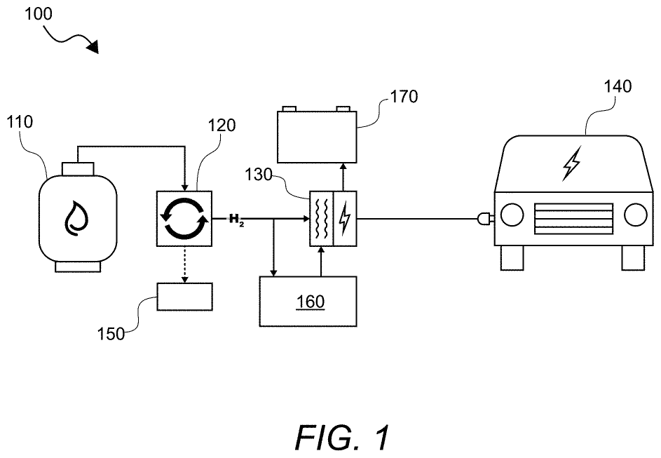

FIG. 1 shows a system 100 of the inventive subject matter in isolation. The system 100 includes a feedstock (e.g., natural gas or other light hydrocarbon) source 110 that is fluidly coupled to a reformer 120.

The feedstock source 110 can be a feedstock supply line leading to the location of the system 100 from a supplier (e.g., a natural gas line to a location). In embodiments, the feedstock source 110 can be a tank or reservoir of feedstock.

In the discussion herein, references are made to the use of natural gas as an example of a suitable feedstock. However, it is understood that other suitable light hydrocarbons could be used.

It has now been discovered that this can be accomplished using a non-thermal plasma to reform the feed gas into substantially pure (≤5% wt/wt impurities) H2 and carbon, and feeding the H2 into fuel cells to produce the electricity.

The nomenclature for nonthermal plasma (“NTP”) found in the scientific literature is varied. In some cases, the plasma is referred to by the specific technology used to generate it (“gliding arc”, “plasma pencil”, “plasma needle”, “plasma jet”, “dielectric barrier discharge”, “Piezoelectric direct discharge plasma”, etc.), while other names are more generally descriptive, based on the characteristics of the plasma generated (“one atmosphere uniform glow discharge plasma”, “atmospheric plasma”, “ambient pressure nonthermal discharges”, “non-equilibrium atmospheric pressure plasmas”, etc.). The two features which distinguish NTP from other mature, industrially applied plasma technologies, is that they are 1) nonthermal and 2) operate at or near atmospheric pressure.

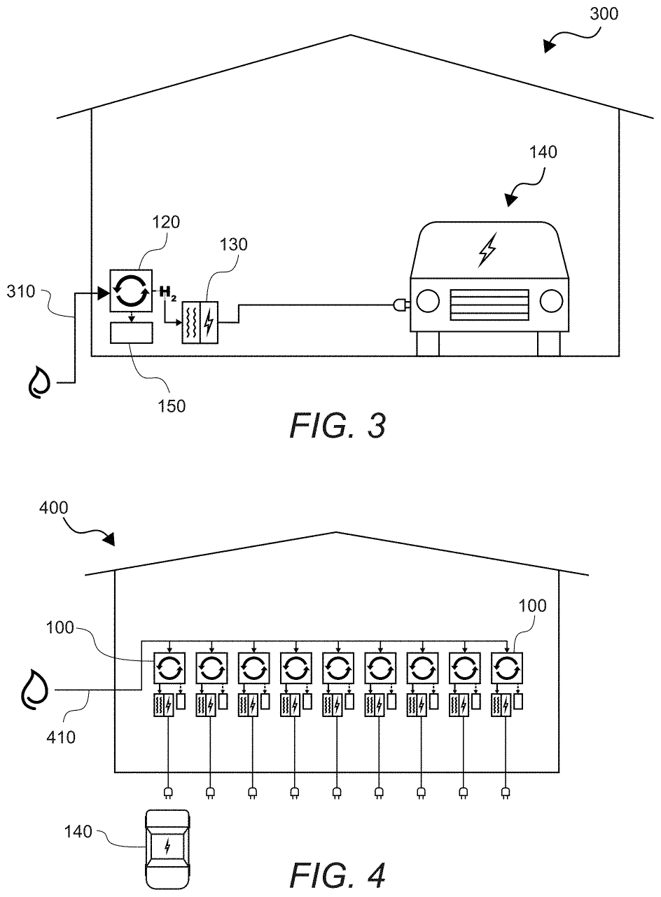

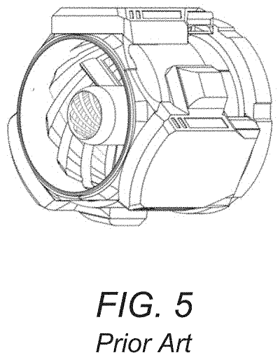

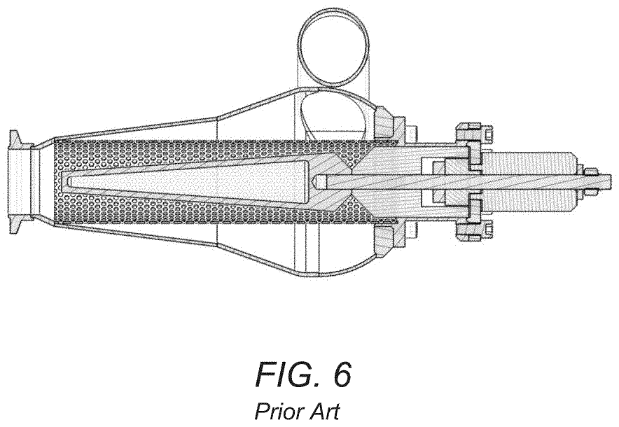

Reformer 120 used in the systems and methods of the inventive subject matter typically include cold plasma reformers that can be used in this fashion, for example those described in U.S. Pat. No. 10,293,303 to Hill or U.S. Pat. No. 10,947,933 to Hill, which are incorporated in their entirety herein by reference. While such devices are primarily taught to treat intake flows or exhaust flows to increase combustion efficiency or otherwise reduce harmful combustion emissions, surprisingly such devices are unexpectedly effective at reforming hydrocarbons to separate hydrogen from carbon and produce nearly pure H2 and carbon (e.g., carbon black) at a high rate of efficiency without pollutants. See '303 Patent at FIG. 14B or '933 Patent at FIG. 3 for examples of such devices. Such devices can be used stand-alone or arranged in a serial or parallel fashion, either linearly, recursively, or nested, etc. FIG. 14B of the '303 patent is reproduced here as FIG. 5 and FIG. 3 of the '933 patent is reproduced here as FIG. 6.

The reformer 120 is the fluidly coupled with at least one fuel cell 130, to which it supplies hydrogen as fuel. The fuel cell(s) 130 use the supplied hydrogen to generate electricity. In embodiments, the fuel cell(s) 130 can be electrically coupled with an electric vehicle 140 (here shown represented by electric motor 140) at a charging station and the electricity produced can be used to charge the batteries of electric vehicle 140. As seen in FIG. 1A, the system 100 also includes a carbon storage container 150 that is fluidly coupled with the reformer 120 to store carbon byproduct. The steps of the methods of the inventive subject matter will be discussed in further detail below.

The system 100 optionally includes an H₂ storage tank 160 that can be used to store hydrogen produced by the reformer 120. The storage tank 160 can then be used to supply stored hydrogen to the fuel cell 130.

In embodiments of the inventive subject matter, the system 100 includes a filter (such a carbon separator) coupled with the output end of the reformer 120. An example of a suitable filter is a cyclone type filter, though other suitable filters are also contemplated. The filter separates the hydrogen produced by the reformer 120 from the carbon byproduct. The carbon byproduct is then directed to the carbon storage container 150.

In embodiments of the inventive subject matter, the system 100 can also optionally include a battery 170 used to store electric energy from the fuel cells. The electricity stored by battery 170 can be used to store only excess energy, or can be a primary recipient of all electricity for later distribution. The battery 170 can, in embodiments, also provide electricity to the load 140.

In embodiments of the inventive subject matter, the system 100 includes a filter (such a carbon separator) coupled with the output end of the reformer 120. An example of a suitable filter is a cyclone type filter, though other suitable filters are also contemplated. The filter separates the hydrogen produced by the reformer 120 from the carbon byproduct. The carbon byproduct is then directed to the carbon storage container 150.

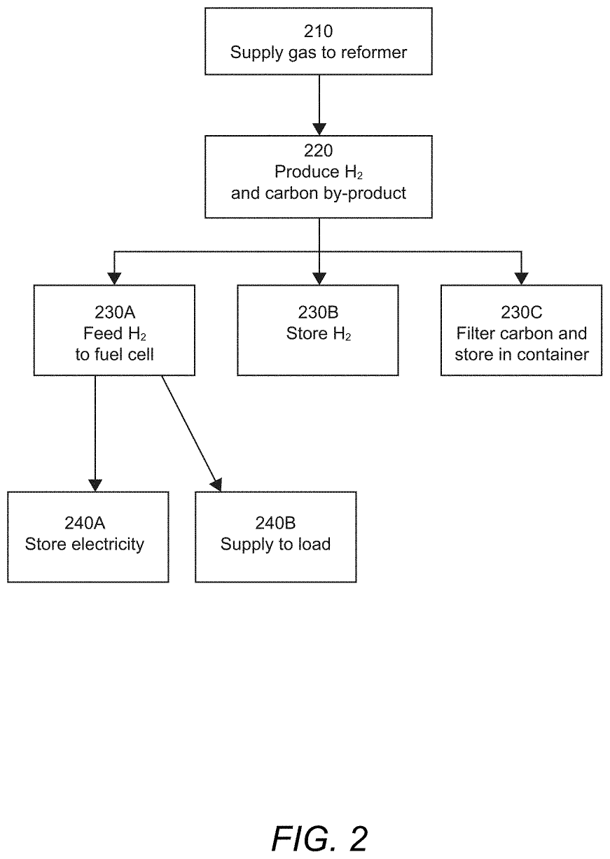

FIG. 2 provides a flowchart of the processes executed according to embodiments of the inventive subject matter.

At step 210, the feedstock source 110 supplies natural gas to the reformer 120.

At step 220, the reformer 120 generates hydrogen from the natural gas, with carbon as a byproduct. One or more of the components of the system 100 can be controlled by a computer and/or have a programmable on-board processor. Thus, for example, the production of hydrogen at step 220 can be controlled based on a demand for electricity at any particular moment. If a demand for electricity increases, the reformer 120 can receive a command to increase hydrogen production accordingly. Likewise, for a drop in demand, the reformer 120 can receive a command to decrease the production of hydrogen.

At step 230A, the hydrogen is fed to the fuel cell(s) 130 for conversion to fuel. Because the production of hydrogen can be controlled by the reformer 120, the supply of hydrogen to the fuel cell(s) 130 can be considered to be contemporaneous for their use as fuel at step 230A.

Having produced the electricity at step 230A, the system 100 can then store the electricity in the battery 170 (in embodiments where a battery 170 is present in system 100) at step 240A at the charging site (for later immediate distribution) or provide it to a vehicle 140 to charge the vehicle's batteries at step 240B.

At step 230B, the hydrogen produced by the reformer 120 can be stored for later use in tank 160 (in embodiments where the tank 160 is present in system 100).

The carbon byproduct is filtered out and stored in the container 150 at step 230C. In embodiments of the inventive subject matter, the carbon byproduct comprises at least 20% nanostructure carbon. In these embodiments, the nanostructure carbon is further separated from the generated carbon byproduct.

In embodiments, the electricity produced by fuel cell(s) 130 can be used to compress the carbon byproduct such that it is more densely stored in storage 150.

FIG. 3 shows the system 100 deployed in a house 300, and used to charge an electric car 140. As seen in FIG. 3, natural gas line 310 supplies natural gas to the reformer 120, which then generates hydrogen that fuel cell(s) 130 use to generate electricity according to the processes discussed above. The electricity is then used to charge electric car 140 when it is plugged into system 100.

FIG. 4 shows a charging station for electric vehicles that incorporate a plurality of stations each having system 100. In these cases, the natural gas line 410 supplies the feedstock necessary to each station to generate hydrogen and then electricity at each location, such that a vehicle 140 can be recharged when it is plugged into the recharging station.

In this embodiment as well as other embodiments of the system 100 shown herein, the system 100 can include a pump that can be used to store gasses under pressure. The pump could be located between the natural gas supply 110 (gas line 410 in FIG. 4) and the reformer 120 such that the natural gas is supplied at an appropriate pressure. A pump could additionally/alternatively used at the hydrogen output of the reformer 120 so that they hydrogen is fed to the fuel cells 130 at the appropriate pressure.

In embodiments, the generated electricity by the fuel cell(s) 130 is also used to power other components of the system 100, such as the reformer 120. In these embodiments, the initial power can be supplied by a battery or other source to get the system 100 producing enough electricity to power itself and recharge a plugged-in vehicle.

Contemplated vehicles can include aircraft, spacecraft, California DMV class vehicle, a locomotive, a propeller vehicle, a turbine vehicle, a sea craft/marine vehicle, or a construction vehicle.

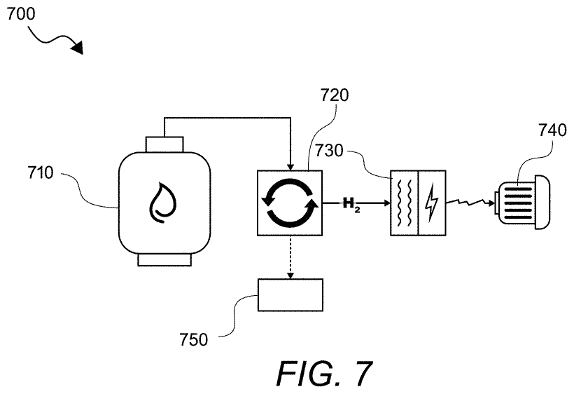

FIG. 7 depicts system 700 of the inventive subject matter. Feedstock in the form of natural gas is supplied from feed 710 to plasma reformer 720 to produce (nearly) pure H2 and carbon (e.g., carbon black). The H2 and carbon are separated and diverted, with carbon sent to receptacle 750 for further processing (e.g., compression, sorting nanostructure carbon, etc.) while the H2 is sent to fuel cell 730. Fuel cell 730 uses the H2 to produce electricity, which is then sent to electric device or motor 740. H2 can further be diverted for pressurization or to a tank for storage. Likewise, electricity generated from the fuel cell is used to power the reformer or diverted to a battery for storage.

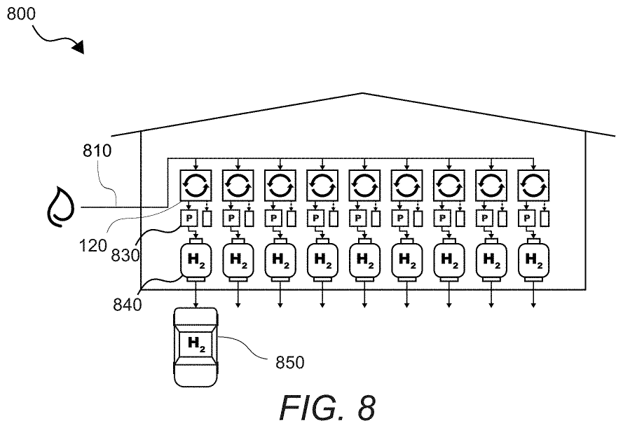

FIG. 8 depicts system 800 of the inventive subject matter. In this use case, feedstock in the form of natural gas 810 is supplied to a series of plasma reformers 120. Each reformer 120 in turn separates (nearly) pure H2 from carbon, routes the H2 to pressurizers 830 for storage in tanks 840, and supplies the pressurized H2 to vehicle 850 powered by a fuel cell.

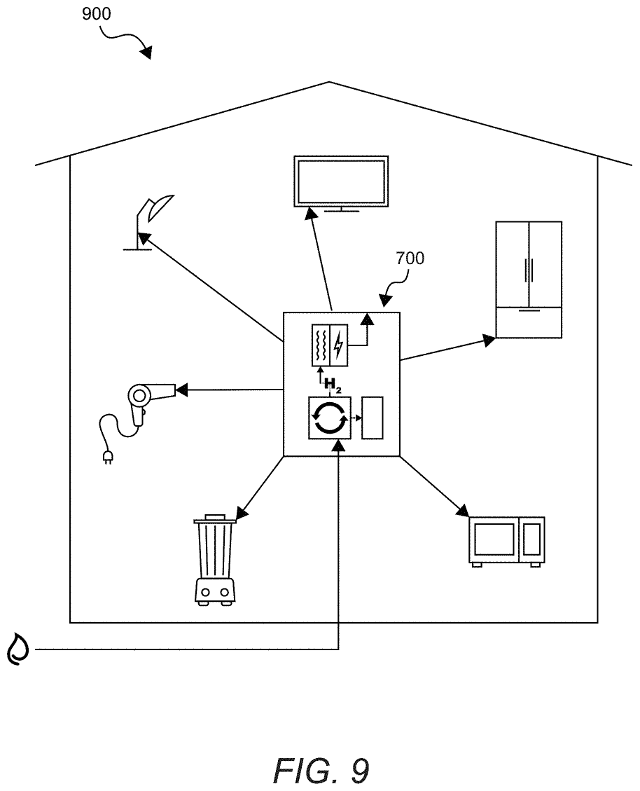

FIG. 9 shows the system 700 deployed in a house 900, where it used to generate electricity for a plurality of electrical home appliances.

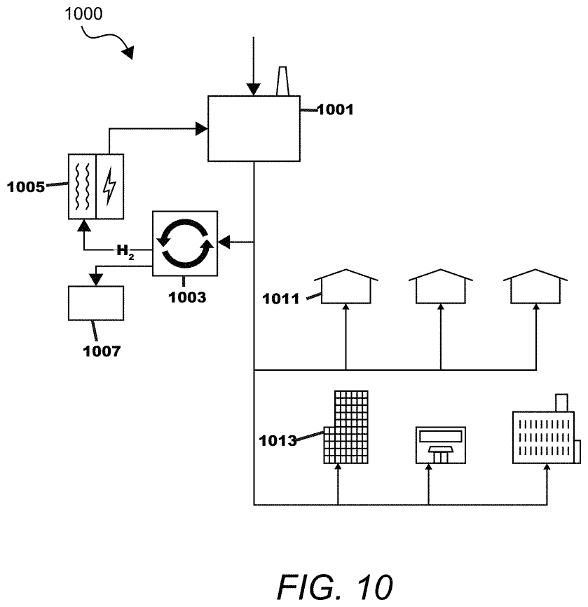

The inventors have discovered that part of a hydrocarbon distribution system having a plurality of operating nodes can be operated through an innovative use of a reformer and fuel cell. As shown in FIG. 10, a reformer 1003 is fluidly coupled to a hydrocarbon supply line of the hydrocarbon distribution system 1000. Reformer 1003 is configured to generate H2. It is contemplated that the H2 can be fed to a fuel cell 1005 to generate electricity that is used to power an operating node of hydrocarbon distribution system 1000.

The hydrocarbon supply line can comprise natural gas that is fed to homes 1011 and other buildings 1013. Reformer 1003 can comprise a plasma device, such as a cold plasma reformer. It is contemplated that nonthermal plasma can be used by the cold plasma reformer to generate H2. In contemplated embodiments, carbon can also be generated by reformer 1003. The carbon can be compressed in a compressor 1007 and distributed elsewhere.

The operating node can be one of a compressor station, a processing station, a gate station, a distribution station of hydrocarbon distribution system 1001. Electricity generated from fuel cell 1005 can be used to power some or all of a compressor station, a processing station, a gate station, and a distribution station. It is contemplated that generated electricity can be stored at a battery coupled to the operating node. Additionally, or alternatively, generated H2 can be stored at the operating node.

Furthermore, the generated electricity or generated H2 can be used to supply at least one of a California DMV class of vehicle, a construction vehicle, a piece of field equipment, a locomotive, or a transport ship at the operating node.

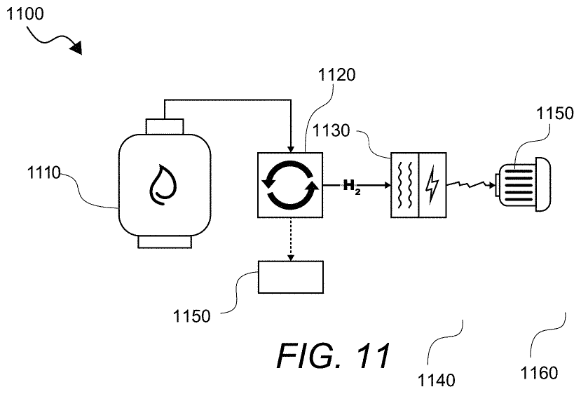

FIG. 11 depicts system 1100 of the inventive subject matter to modify a hydrocarbon distribution point to include a H2 distribution point. Feedstock 1110 in the form of natural gas is supplied to plasma reformer 1120 to produce (nearly) pure H2 and carbon (e.g., carbon black). The H2 and carbon are separated and diverted, with carbon sent to 1150 receptacle for further processing or disposal (e.g., compression, sorting nanostructure carbon, etc.) while the H2 is sent pressurizer 1140 to be stored or otherwise distributed to hydrogen vehicle 1160 (e.g., fuel cell electric vehicle). Also pictured, the H2 can be sent to fuel cell 1130 to produce electricity for storage or to charge electric vehicle 1150. The H2 distribution and electricity distribution can be included together in the alternative. Whether electricity is supplied to a vehicle or not, the electricity is preferably used to power the reformer, the H2 distribution, or diverted to a battery for storage.

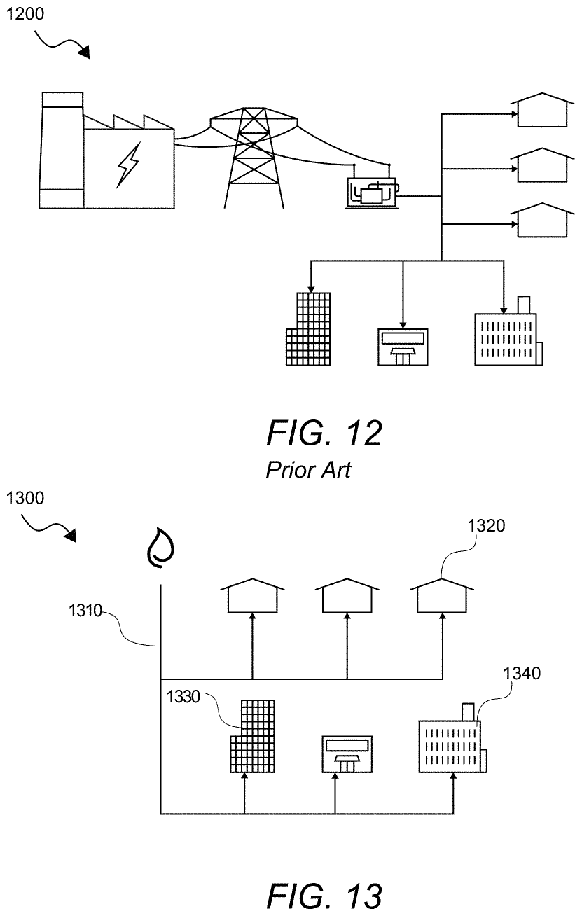

FIG. 12 depicts prior art system 1200 for distribution of electricity in a power grid. Electricity is generated at a central utility point and distributed to residential, commercial, and industrial users.

FIG. 13 depicts system 1300 of the inventive subject matter. Here, a prior art power grid is supplemented (or replaced) by a feedstock based distributed power network. Feedstock in the form of 1310 natural gas is supplied to residential users 1320, commercial users 1330, and industrial users 1340. At each distribution point, the natural gas is reformed into (nearly) pure H2 and then stored or used by a fuel cell to produce electricity, for example by use of system 700 of FIG. 7. The electricity is either used at the local site (e.g., operating commercial building, residential, industrial, etc.) or is used to supplement the electricity needs of the area or local grid. Any carbon black generated can likewise be collected and sold back to a carbon black supplier to favorably offset feedstock or maintenance costs.

The description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An electric vehicle filling station, comprising:
a feedstock source fluidly coupled with a reformer, wherein the reformer generates H2 from the feedstock;
a fuel cell fluidly coupled to the reformer, wherein the fuel cell generates electricity from the H2 ;
an electric transmission point for providing the generated electricity to an electric vehicle.

2. The station of claim 1, further comprising a battery coupled to the fuel cell to store generated electricity.

3. The station of claim 1, wherein the feedstock is natural gas or other hydrocarbon.

4. The station of claim 1, further comprising a storage component coupled to the reformer to store H2 .

5. The station of claim 1, further comprising a H2 transmission point for providing the generated H2 to the electric vehicle.

6. The station of claim 1, wherein the reformer comprises a plasma device.

7. The station of claim 1, wherein the generated electricity powers the reformer.

8. The station of claim 1, wherein the electric vehicle comprises a land vehicle, an aircraft, a marine vessel, or a spacecraft.

9. The station of claim 1, wherein the reformer further generates carbon from the feedstock.

10. The station of claim 9, further comprising a carbon repository fluidly coupled to the reformer.

11. The station of claim 9, wherein the generated electricity further powers compression of the generated carbon.

12. The station of claim 9, wherein the generated carbon comprises at least 20% nanostructure carbon.

13. The station of claim 9, wherein nanostructure carbon is separated from the generated carbon.

14. A method of fueling an electric vehicle from a feedstock, comprising:
using a reformer to generate H2 from a feedstock;
providing fuel to an electric vehicle, wherein the fuel comprises generated H2 or electricity generated by a fuel cell from H2 .

15. The method of claim 14, wherein the reformer comprises a plasma device.

16. The method of claim 14, further comprising generating electricity with a fuel cell from generated H2 .

17. The method of claim 16, wherein the generated electricity powers the reformer.
